(19) United States
(12) Patent Application Publication
(10) Pub. No.: US 2013/0070444 A1
(43) Pub. Date: Mar. 21, 2013

(54) CONTROL METHOD FOR BACKLIGHT OF AN INPUT DEVICE AND DEVICE THEREOF

(71) Applicants: SASCHA FLORIAN KROHN, New Taipei City (TW); Kuo-Hwa Huang, New Taipei City (TW)

(72) Inventors: SASCHA FLORIAN KROHN, New Taipei City (TW); Kuo-Hwa Huang, New Taipei City (TW)

(21) Appl. No.: 13/236,626

(22) Filed: Sep. 19, 2011

(51) Int. Cl. G09F 13/04

(52) U.S. Cl. 362/97.1

(57) ABSTRACT

By controlling brightness and/or a color output of a backlight of the computer input device in response to the input frequency and/or the number of keys being pressed simultaneously, the user can sense feedback according to the user's input performance.

### BACKGROUND OF THE INVENTION

1. Field of the Invention

The present invention is related to a control method for backlight of a computer input device and device thereof, and more particularly, to a control method for controlling backlight of a computer input device according to input received by the input device.

2. Description of the Prior Art

Computer input devices such as keyboards or mice etc., are usually standard input equipments. As computer technology evolves, keyboards and mice still retain similar forms. Light emitting devices, or backlights, have been disposed in some computer input devices for the benefit of increased visibility in dimmed environment, or enhanced visual effect.

However, the conventional computer input device, or the conventional driving method thereof may not suffice for certain circumstances. The backlight of the conventional computer input device usually emits a single color light. The brightness and color output of the conventional computer input device does not vary according to a user input such as input frequency or the number of keys pressed simultaneously. Hence the conventional method for driving the backlight of the computer input device does not provide feedback to the user. For applications such as electronic sports or gaming keyboards, the conventional method for driving the keyboard only fulfills the role of an input device, and does not improve user experience since the brightness and/or the color output of the backlight of the keyboard do not vary according to the user input such as input frequency or the number of keys pressed simultaneously etc.

### SUMMARY OF THE INVENTION

The present invention discloses a control method for backlight of an input device. The control method comprises receiving input by the input device; generating an input frequency in response to the input; and controlling brightness and/or a color output of the backlight of the input device in response to the input frequency.

The present invention further discloses a control method for backlight of an input device. The control method comprises receiving input by the input device; generating number of keys being pressed simultaneously in response to the input; and controlling brightness and/or a color output of the backlight of the input device in response to the number of keys being pressed simultaneously.

The present invention further discloses a computer input device. The computer input device comprises a key module, a backlight module, and a control module. The backlight module is for generating backlight. The control module is coupled to the key module and the backlight module. The control module controls the backlight module according to input received by the key module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a computer input device according to an embodiment of the present invention.

FIG. 2 is a diagram illustrating a control method for backlight of the computer input device according to an embodiment of the present invention.

FIG. 3 is a diagram illustrating a control method for backlight of the computer input device according to another embodiment of the present invention.

FIG. 4 is a diagram illustrating a computer input device according to another embodiment of the present invention.

FIG. 5 is a diagram illustrating a first computer input device according to an embodiment of the present invention.

### DETAILED DESCRIPTION

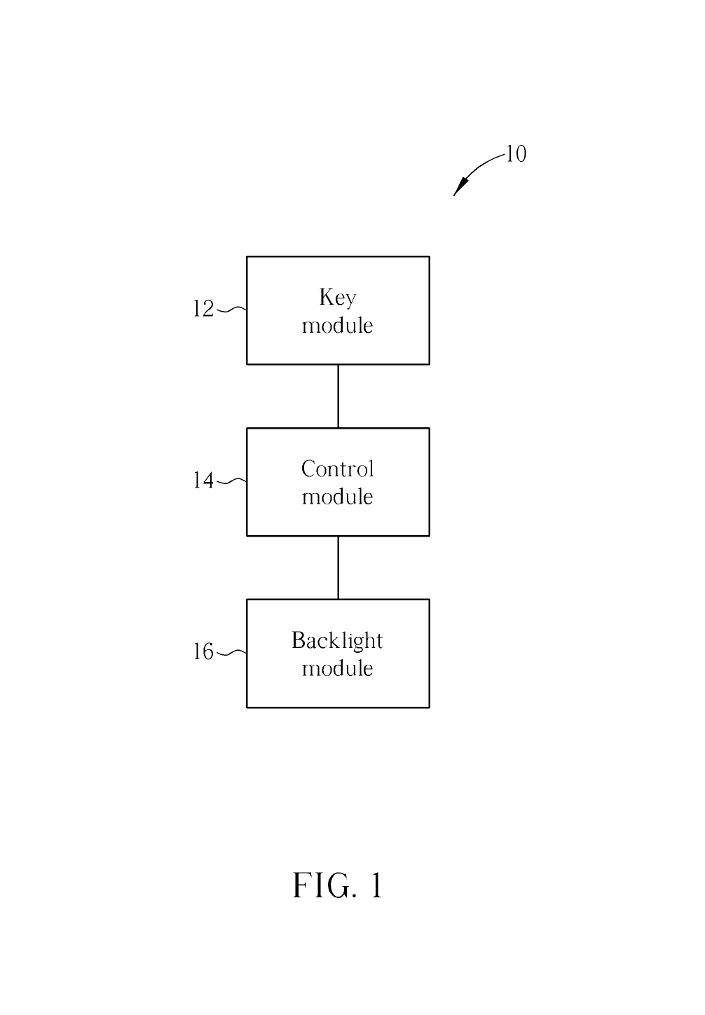

Please refer to FIG. 1. FIG. 1 is a diagram illustrating a computer input device 10 according to an embodiment of the present invention. The computer input device 10 comprises a key module 12, a control module 14 and a backlight module 16. The key module 12 and the backlight module 16 are coupled to the control module 14. The key module 12 comprises one or more input interface, such as keys of a keyboard. The backlight module 16 of the computer input device 10 is used to generate backlight. The control module 14 controls the backlight module 16 in response to the input received by the key module 12. Further, the control module 14 can control the backlight module 16 for generating varied brightness and/or varied colored lights in response to the input frequency. Another, the control module 14 can control the backlight module 16 for generating varied brightness and/or varied colored lights in response to a number of keys pressed.

In the present embodiment, the computer input device 10 can be realized with a keyboard and the key module 12 can be realized with a key pad of the keyboard. The control module 14 can comprise firmware, installed on a computer device in which the computer input device 10 is coupled to. In another embodiment, the control module 14 can comprise a microprocessor disposed in the computer input device 10. The backlight module 16 can comprise one or more light emitting unit such as a light emitting diode (LED), where the light emitting diode may emit multiple colored lights.

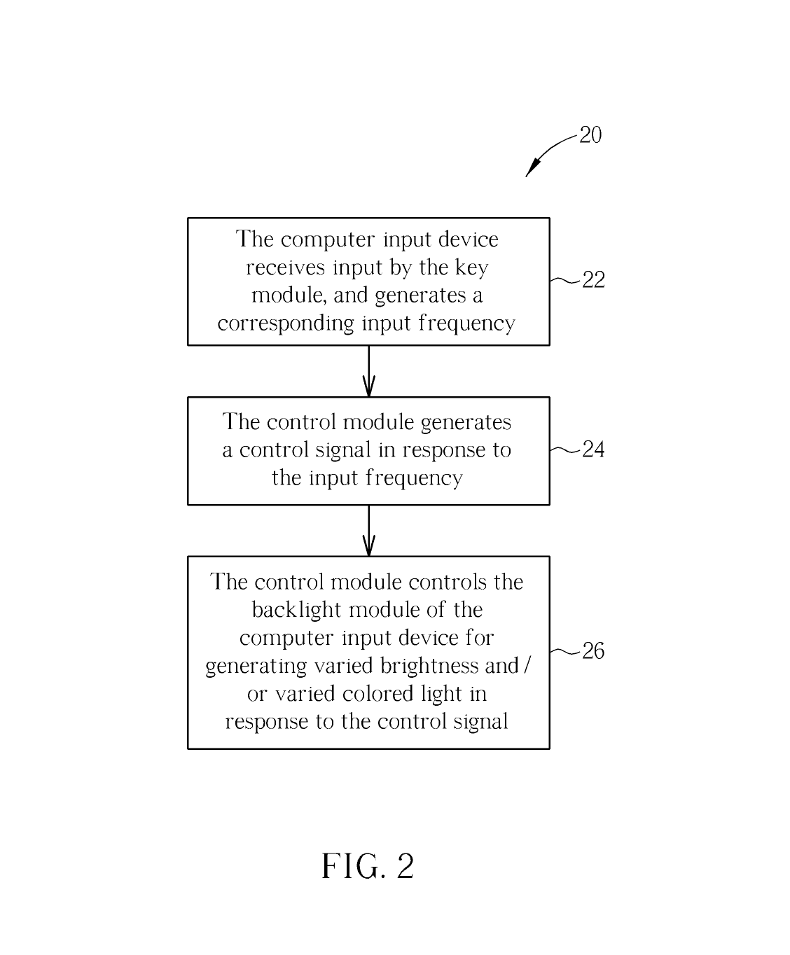

Please refer to FIG. 1 and FIG. 2. FIG. 2 is a diagram illustrating a control method 20 for backlight of the computer input device 10 according to an embodiment of the present invention. Steps of the control method 20 of the present invention include:

Step 22: the computer input device 10 receives input by the key module 12, and generates a corresponding input frequency;

Step 24: the control module 14 generates a control signal in response to the input frequency; and

Step 26: the control module 14 controls the backlight module 16 of the computer input device 10 for generating varied brightness and/or varied colored lights in response to the control signal.

The input frequency in step 22 may be defined as number of inputs performed by a user within predetermined time duration (e.g. frequency of key strokes). The relation between the brightness of the backlight module 16 and the input frequency can be configured by the user according to practical demands. In step 26 of the present embodiment, the control module 14 controls the backlight module 16 of the computer input device 10 to generate varied brightness by the corresponding input frequency. For instance, the faster the user types, the backlight module 16 emits brighter light, and vice versa.

In step 26, the control module 14 can also control the backlight module 16 to generate varied colored lights by the corresponding input frequency. The relation between the colored lights generated from the backlight module 16 and the input frequency can also be configured by the user according to practical demands. For instance, the backlight module 16 can generate a warmer colored light (e.g. lower color temperature) in response to a higher input frequency, and generate a cooler colored light (e.g. higher color temperature) in response to a lower input frequency.

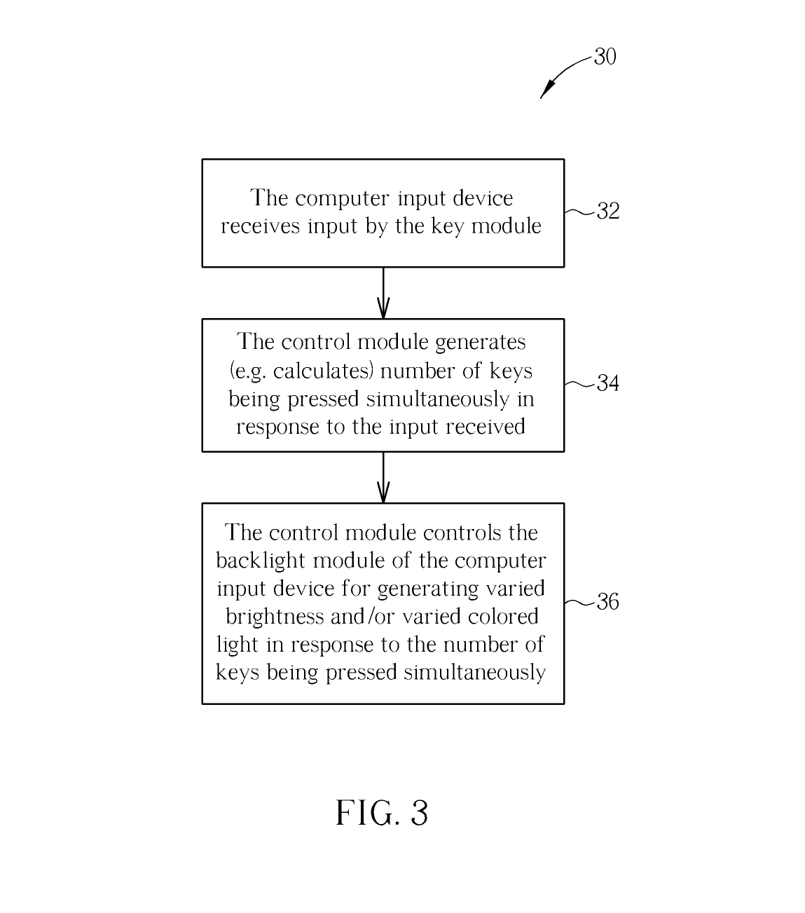

Please refer to FIG. 1 and FIG. 3. FIG. 3 is a diagram illustrating a control method 30 for backlight of the computer input device 10 according to another embodiment of the present invention. Steps of the control method 30 of the present invention include:

Step 32: the computer input device 10 receives input by the key module 12;

Step 34: the control module 14 generates (e.g. calculates) number of keys being pressed simultaneously in response to the input received; and

Step 36: the control module 14 controls the backlight module 16 of the computer input device 10 for generating varied brightness and/or varied colored lights in response to the number of keys being pressed simultaneously.

In step 36 of the present embodiment, the control module 14 controls the backlight module 16 of the computer input device 10 for generating varied brightness to change with the number of keys of the key module 12 being pressed simultaneously. For instance, when the user presses more keys simultaneously, the backlight module 16 emits brighter light, and vice versa. In theory, the backlight module 16 emits a brightest light when all keys of the key module 12 are pressed. However, there are occasions in which it is rare for all keys of the key module 12 to be pressed simultaneously. For instance, the user does not usually require to press all keys of a keyboard at the same time. Hence, the number of keys being pressed simultaneously can be defined by the user according to practical demands. In other words, the number of keys required to be pressed simultaneously for the backlight module 16 to emit different brightness can be configured by the user through the control module 14.

In step 36, the control module 14 of the computer input device 10 can also control the backlight module 16 of the computer input device 10 for generating varied colored lights in response to the number of keys being pressed simultaneously. Similar to the embodiment shown in FIG. 2, the relation between the colored lights generated from the backlight module 16 and the input frequency can also be defined by the user defined according to practical demands. In other words, the number of keys required to be pressed simultaneously for the backlight module 16 to emit different colored light can be configured by the user through the control module 14. For instance, the backlight module 16 can be configured to generate a warmer colored light (e.g. lower color temperature) when more keys are pressed simultaneously, and generate a cooler colored light (e.g. higher color temperature) when fewer keys are pressed simultaneously.

This way, the computer input device 10 provides the user a sense of feedback regarding the user's performance, such as how fast the user types or the number of keys the user presses simultaneously. The user may exercise different control patterns for different applications. For instance, for real-time strategy (RTS) games the user constantly utilizes different keys for controlling, hence the control module 14 of the computer input device 10 can control the backlight module 16 to generate varied brightness and/or varied colored lights in response to the input frequency (e.g. key-in frequency) of the user. For applications such as first person shooter games (FPS), the user makes use of the direction keys (e.g. the “W”, “S”, “A” and “D” keys) to move around almost all the time, so the input frequency of the user may not be an accurate measure for the user performance. Hence, the control module 14 of the computer input device 10 can control the backlight module 16 to generate varied brightness and/or varied colored lights in response to the number of keys being pressed simultaneously for applications like first person shooter games.

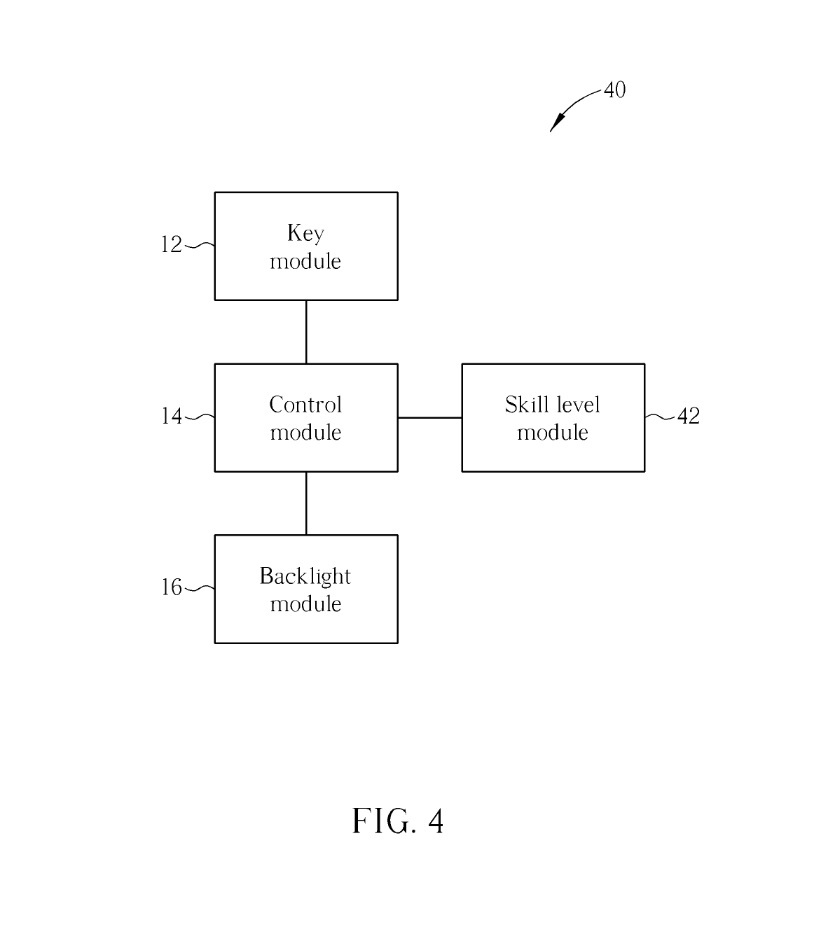

Please refer to FIG. 4. FIG. 4 is a diagram illustrating a computer input device 40 according to another embodiment of the present invention. The computer input device 40 is similar to the computer input device 10 in FIG. 1. The difference is that the computer input device 40 further comprises a skill level module 42, coupled to the control module 14. The skill level module 42 can be realized with a physical switch, or a software option in the firmware of the computer input device 10, etc. The skill level module 42 can be adjusted to different levels, such as “amateur”, “intermediate” and “professional”, etc.

For the same user input frequency or same number of keys being pressed simultaneously, different brightness and/or different colored light generated from the backlight module 16 of the computer input device 40 may be resulted in response to different settings of the skill level module 42. In other words, the brightness and/or the colored light of the backlight module 16 of the computer input device 40 can be controlled in response to the skill setting of the skill level module 42 and the input frequency of the user. The brightness and/or the colored light of the backlight module 16 of the computer input device 40 can also be controlled in response to the skill setting of the skill level module 42 and the number of keys of the computer input device 40 being pressed simultaneously.

Different skill levels of the skill level module 42 can correspond to different input frequencies required for the backlight module 16 to emit lights of the same brightness or the same colored light. For instance, when the skill setting of the skill level module 42 is set to low (e.g. amateur level), the backlight module 16 of the computer input device 40 generates a first brightness and/or a first colored light if the user achieves a first input frequency (e.g. key-in frequency) to the computer input device 40. When the skill setting is set to high (e.g. professional level), the backlight module 16 of the computer input device 40 generates the first brightness and/or the first colored light if the user achieves a second input frequency (e.g. key-in frequency) that is higher than the first input frequency to the computer input device 40.

In another embodiment, different skill levels of the skill level module 42 can correspond to different numbers of keys required to be simultaneously pressed for the backlight module 16 to emit lights of the same brightness or the same color. For instance, when the skill setting of the skill level module 42 is set to low (e.g. amateur level), the backlight module 16 of the computer input device 40 generates a first brightness and/or a first colored light if a first number of keys are pressed simultaneously. When the skill setting is set to high (e.g. professional level), the backlight module 16 of the computer input device 40 generates the first brightness and/or the first colored light if a second number of keys are pressed simultaneously, where the second number of keys is more than the first number of keys.

This way, the skill level module 42 of the computer input device 40 can be adjusted according to the user's preference and performance such as key-in frequency and/or the number of keys being pressed simultaneously, etc. Skilled users may set the skill level module 42 to a higher skill level to increase the requirement for the computer input device 40 to generate lights of certain brightness and/or color, for a sense of challenge. Amateur users may set the skill level module 42 to a lower skill level to decrease the requirement for the computer input device 40 to generate lights of certain brightness and/or color, for enjoying the visual effect of the computer input device 40 without much effort.

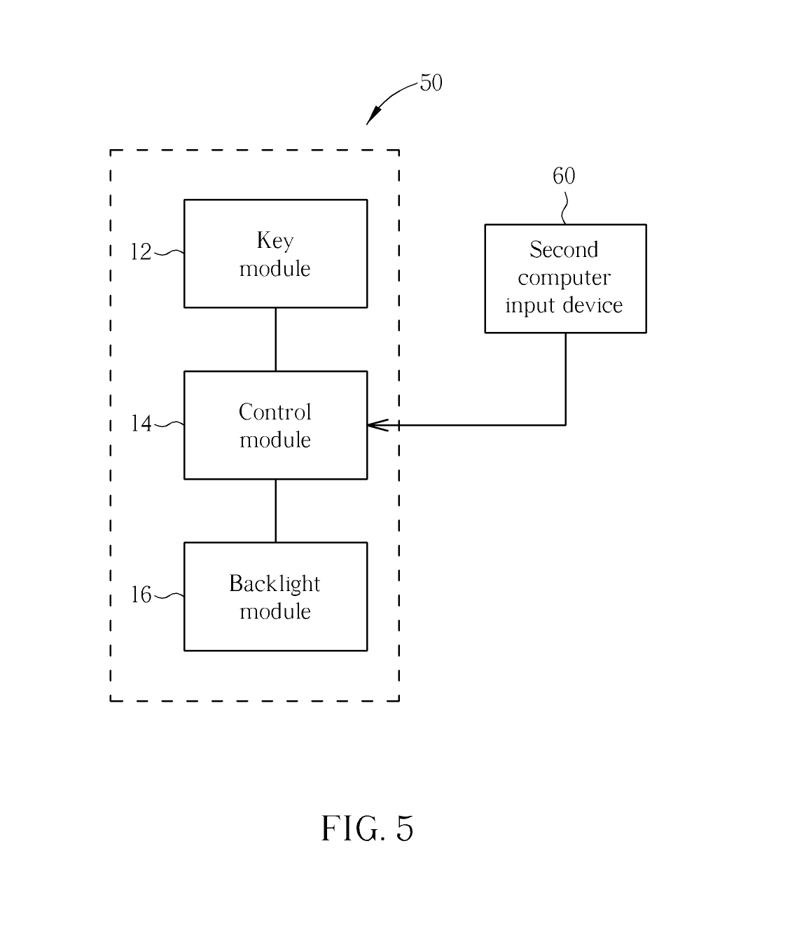

Please refer to FIG. 5. FIG. 5 is a diagram illustrating a first computer input device 50 according to an embodiment of the present invention. As illustrated in FIG. 5, the first computer input device 50 is similar to the computer input device 10 in FIG. 1. The difference is that the control module 14 of the first computer input device 50 further receives an input of a second computer input device 60. For instance, the first computer input device 50 and the second computer input device 60 can be realized with a keyboard and a mouse respectively. In the present embodiment, the control module 14 of the first computer input device 50 controls the backlight module 16 to generate varied brightness and/or varied colored lights in response to the input received by the key module 12 of the first computer input device 50 and the second computer input device 60.

For instance, the control module 14 of the first computer input device 50 controls the backlight module 16 to generate varied brightness and/or varied colored lights in response to input frequencies of the first computer input device 50 and the second computer input device 60. In another embodiment, the control module 14 of the first computer input device 50 controls the backlight module 16 to generate varied brightness and/or varied colored lights in response to the number of keys of the first computer input device 50 and the second computer input device 60 being pressed simultaneously.

Please note that the above embodiments of the computer input device and method thereof are merely exemplary illustrations of the present invention, those skilled in the art can certainly make appropriate modifications according to practical demands, such as controlling the backlight module of the computer input device to gradually switch between different brightness or different color outputs so as to create a “breath” visual effect, which also belongs to the scope of the present invention.

In conclusion, the present invention discloses a control method for backlight of a computer input device. The method controls brightness and/or a color output of the backlight of the computer input device in response to the input frequency. Moreover, the method controls brightness and/or a color output of the backlight of the computer input device in response to the number of keys being pressed simultaneously, etc. The input frequency and the number of keys being pressed simultaneously are generated according to the input received by the computer input device. This way, the method of the present invention can provide the user a sense of feedback according to the user's input performance. This may motivate the user to, say, strive for better performances, blend into the gaming atmosphere, or simply type faster. The audience can also get a sense of the user's input performance according to the brightness and/or the color output of the backlight of the computer input device. As a result, the user experience is enhanced for not only the user but also the audience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method for backlight of an input device, comprising:
receiving input by the input device;
generating an input frequency in response to the input received by the input device; and
controlling brightness and/or color output of the backlight of the input device in response to the input frequency.

2. The control method of claim 1, wherein the brightness of the backlight of the input device changes with the input frequency.

3. The control method of claim 1 further comprising:
setting a skill setting; and
controlling the brightness and/or the color output of the backlight of the input device in response to the skill setting and the input frequency.

4. The control method of claim 3, wherein according to the skill setting, the backlight of the input device displays a first brightness and/or a first color if the input device achieves a first input frequency, the backlight of the input device displays the first brightness and/or the first color if the input device achieves a second input frequency, and the second input frequency is higher than the first input frequency.

5. A control method for backlight of an input device, comprising:
receiving input by the input device;
generating number of keys being pressed simultaneously in response to the input received by the input device; and
controlling brightness and/or a color output of the backlight of the input device in response to the number of keys being pressed simultaneously.

6. The control method of claim 5, wherein the brightness of the backlight of the input device changes with the number of keys being pressed simultaneously.

7. The control method of claim 5 further comprising:
setting a skill setting; and
controlling the brightness and/or the color output of the backlight of the input device in response to the skill setting and the number of keys being pressed simultaneously.

8. The control method of claim 7, wherein according to the skill setting, the backlight of the input device displays a first brightness and/or a first color if a first number of keys are pressed simultaneously, the backlight of the input device displays the first brightness and/or the first color if a second number of keys are pressed simultaneously, and the second number is larger than the first number.

9. A computer input device, comprising:
a key module;
a backlight module, for generating backlight; and
a control module, coupled to the key module and the backlight module, the control module controlling the backlight module according to input received by the key module.

10. The computer input device of claim 9, further comprising a skill level module, coupled to the control module, wherein the control module controls the backlight module in response to setting of the skill level module and the input received by the key module.

11. The computer input device of claim 9, wherein the control module further receives an input of a second computer input device, and the control module controls the backlight module in response to the input received by the key module and the second computer input device.
